(19) United States
(12) Patent Application Publication
(10) Pub. No.: US 2017/0370456 A1
(43) Pub. Date: Dec. 28, 2017

(54) TORQUE CONVERTER INCLUDING FRONT COVER FLUID FLOW BAFFLES

(71) Applicant: Schaeffler Technologies AG & Co. KG, Herzogenaurach (DE)

(72) Inventor: Pankaj Madhukar PATIL, Wooster, OH (US)

(21) Appl. No.: 15/195,146

(22) Filed: Jun. 28, 2016

(51) Int. Cl. F16H 41/24; F16H 41/28; F16H 45/02

(52) U.S. Cl. CPC F16H 41/24; F16H 45/02; F16H 41/28; F16H 2045/0221; F16H 2045/0215

(57) ABSTRACT

A torque converter is provided. The torque converter includes a front cover including a front radially extending section and a front axially extending section extending axially from an outer radial end of the front radially extending section. The torque converter also includes a plurality of baffle assemblies each including a base connected to the front radially extending section and a support connected to the base. Each of the baffle assemblies includes a first baffle and a second baffle extending radially inward from the respective support. A method of forming a torque converter is also provided. The method includes providing a plurality of baffle assemblies each including a base, a support connected to the base and a first baffle and a second baffle extending from the support; and fixing the bases of the baffle assemblies to a radially extending section of the front cover such that the first and second baffles extend radially inward from the respective support.

The present disclosure relates generally to torque converters and more specifically to the fluid flow baffles in torque converters.

### BACKGROUND

U.S. Pat. No. 8,327,636 discloses a torque converter including a front cover having blades for increasing a fluid flow toward or away from a clutch pack. U.S. Pat. No. 8,789,669 discloses torque converter drive plates that include at least one protrusion for disrupting a Coriolis Effect on fluid in the torque converter.

### SUMMARY OF THE INVENTION

A torque converter is provided. The torque converter includes a front cover including a front radially extending section and a front axially extending section extending axially from an outer radial end of the front radially extending section. The torque converter also includes a plurality of baffle assemblies each including a base connected to the front radially extending section and a support connected to the base. Each of the baffle assemblies includes a first baffle and a second baffle extending radially inward from the respective support.

A method of forming a torque converter is also provided. The method includes providing a plurality of baffle assemblies each including a base, a support connected to the base and a first baffle and a second baffle extending from the support; and fixing the bases of the baffle assemblies to a radially extending section of the front cover such that the first and second baffle assemblies extend radially inward from the respective support.

### BRIEF DESCRIPTION OF THE DRAWINGS

The present invention is described below by reference to the following drawings, in which:

FIG. 1 shows a cross-sectional side view of a torque converter including baffle assemblies according to an embodiment of the present invention;

FIG. 2 shows a stand-alone perspective view of one of the baffle assemblies;

FIG. 3 shows an enlarged cross-sectional side view of the front cover and one of the baffle assemblies; and

FIG. 4 shows a perspective view of the front cover including a plurality of baffle assemblies fixed thereto.

### DETAILED DESCRIPTION

The disclosure provides front cover baffle assemblies to improve response time after coast engagement in a torque converter. The baffle assemblies are radially riveted to front cover and have a beneficial segmented geometry. The segmented baffle assemblies are designed to be nested and include segments bent from opposing sides to provide two baffles per baffle assemblies.

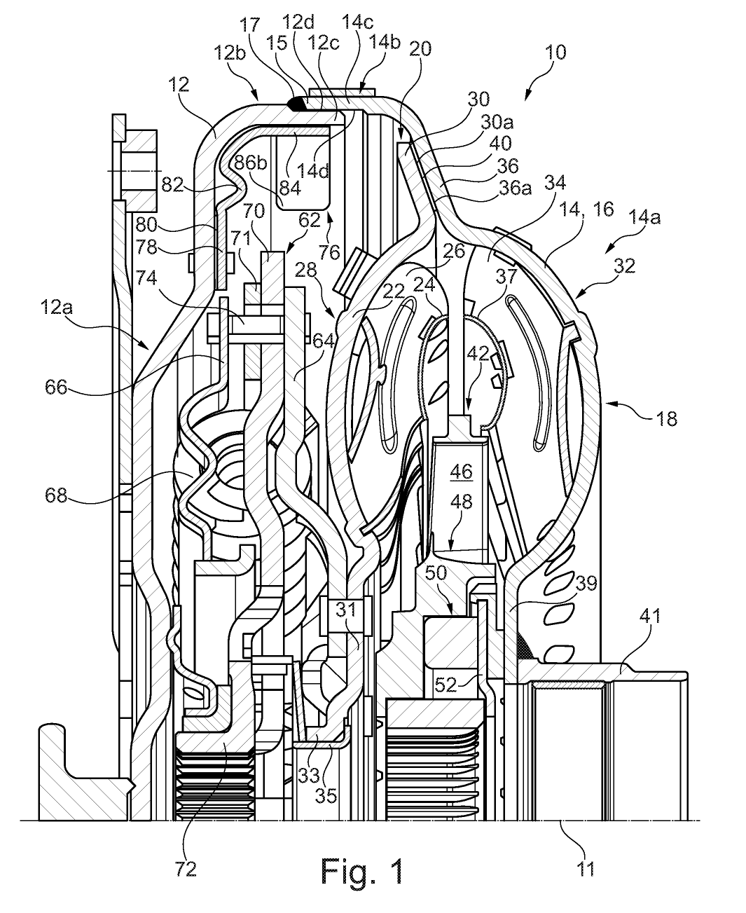

FIG. 1 shows a cross-sectional side view of a torque converter 10 in accordance with an embodiment of the present invention. Torque converter 10 is rotatable about a center axis 11 and includes a front cover 12 for connecting to a crankshaft of an internal combustion engine and a rear cover 14 forming a shell 16 of an impeller or pump 18. The terms axially, radially and circumferentially as used herein are used with respect to center axis 11.

Front cover 12 is substantially cup-shaped and includes a radially extending section 12a that intersects and extends radially away from center axis 11 and an annular axially extending section 12b that protrudes axially at an outer circumference of section 12a. Section 12b, near a rim thereof, is stepped radially inward to define a thinned section 12c having an outer circumferential surface 12d. Rear cover 14 is similarly cup-shaped and includes a radially extending section 14a that forms impeller shell 16 and an annular axially extending section 14b that protrudes axially at an outer circumference of radially extending section 14a. Near a rim 15 of section 14b, section 14b is stepped radially outward to define a thinned section 14c having an inner circumferential surface 14d. Covers 12, 14 are arranged with respect to each other such that sections 12c, 14c overlap each other, with section 12c being receiving inside of section 14c and outer circumferential surface 12d contacting inner circumferential surface 14d. A weld 17 is provided at rim 15 and outer circumferential surface 12d of thinned section 12c to fix front cover 12 and rear cover 14 together.

Torque converter 10 also includes a turbine 20 configured to define a piston that is axially moveable toward and away from impeller 18 to engage and disengage an impeller clutch of impeller 18 so as to form a lockup clutch. Turbine 20 includes a turbine shell 22 and a core ring 24 supporting a plurality of turbine blades 26 therebetween. Turbine shell 22 includes a rounded blade supporting portion 28, which is shaped as an annular bowl, for contacting engine side edges of turbine blades 26. Radially outside of blade supporting portion 28, an outer radial extension 30, which forms the piston, radially protrudes outwardly from an outer circumference of blade supporting portion 28 to define an annular protrusion having a flat annular radially extending impeller facing surface 30a and having an outermost circumference that defines an outermost circumference of turbine 20. Accordingly, the piston and turbine shell 22 are formed as a single piece. Radially inside of blade supporting portion 28, turbine shell 22 includes an annular inner radial extension 31 that, at an inner radial end thereof, joins an axially extending inner circumferential section 33, whose inner circumferential surface contacts an outer circumferential surface of a hub 35.

Impeller 18 includes impeller blades 34, which are each fixed at a transmission side thereof to impeller shell 16 and are each fixed to an impeller core ring 37 at an engine side thereof by tabs. Impeller shell 16, at radially extending section 14a of rear cover 14, includes a rounded blade supporting portion 32, which is shaped as an annular bowl, for contacting transmission side edges of impeller blades 34. Radially outside of blade supporting portion 32, radially extending section 14a includes a radially extending wall 36, which forms an impeller clutch, radially protrudes outwardly from an outer circumference of rounded blade supporting portion 32 to define an annular wall having a flat annular radially extending turbine facing surface 36a. Accordingly, the impeller clutch and impeller shell 16 are formed as a single piece. Radially inside of blade supporting portion 32, radially extending section 14a includes an annular inner radial extension 39 extending radially inward from blade supporting portion 32. A radially inner end of extension 39 is connected to an impeller hub 41.

A friction material 40 is bonded onto radially extending impeller facing surface 30a of outer radial extension 30 for engaging radially extending wall 36. In other embodiments, instead of or in addition to being bonded to outer radial extension 30, friction material 40 may be bonded to radially extending turbine facing surface 36a of radially extending wall 36. Regardless of whether friction material 40 is bonded to outer radial extension 30 or radially extending wall 36, friction material 40 is provided axially between surfaces 30a, 36a.

Torque converter 10 also includes a stator 42 axially between turbine 20 and impeller 18 to redirect fluid flowing from the turbine blades 26 before the fluid reaches impeller 18 to increase the efficiency of torque converter 10. Stator 42 includes a stator casting including a plurality of blades 46 and a stator body 48. Stator 42 also includes a one-way clutch 50 held within stator body 48 by a centering plate 52. An axial thrust washer 54, which is axially between stator 42 and impeller 18, is fixed to stator 42 at an outer circumference of centering plate 52.

A damper assembly 62 is positioned between front cover 12 and turbine 20 and is configured for transferring torque from turbine 20 to a transmission input shaft. Damper assembly 62 includes two cover plates—a turbine side cover plate 64, which is riveted to turbine 20, and a front cover side cover plate 66. Cover plates 64, 66 support a set of arc springs 68 axially therebetween. Damper assembly 62 also includes two drive flanges 70, 71 positioned axially between covers plate 64, 66. Drive flange 70 includes an inner radial hub 72 configured for nonrotatably connecting to a transmission input shaft. Drive flanges 70, 71 both includes circumferentially extending slots for receiving springs 68. Radially outside of springs 68, cover plates 64, 66 are fixed together by a plurality of circumferentially spaced rivets 74.

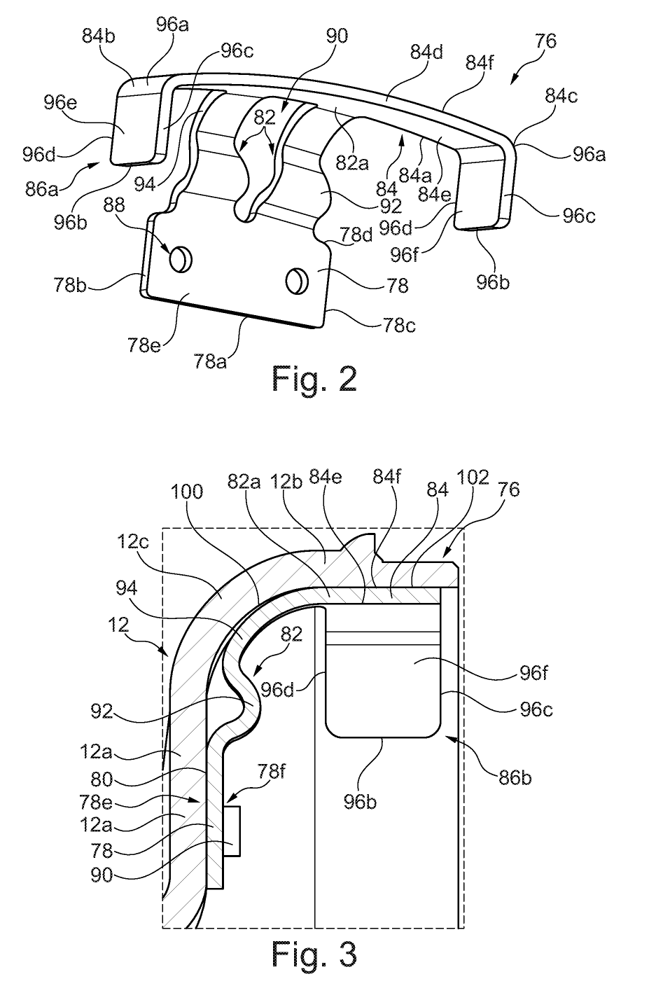

In accordance with an embodiment of the invention, torque converter 10 is provided with a plurality of circumferentially spaced baffle assemblies 76 connected to front cover 12. Baffle assemblies 76 each includes a radially extending base 78 for contacting an inner radially extending surface 80 of radially extending section 12a of front cover 12. Each baffle assembly 76 includes at least one arm 82 extending radially and axially from base 78 to a circumferentially and axially extending support 84—circumferentially extending when viewed axially and axially extending when viewed circumferentially. The two opposing circumferential ends 84a, 84b (FIG. 2) of support 84 are each provided with a respective baffle 86a, 86b extending radially inward from support 84. Baffles 86a, 86b are radially aligned with damper assembly 62 and the overlapping sections 12c, 14d of covers 12, 14, and are axially aligned with outer radial extension 30.

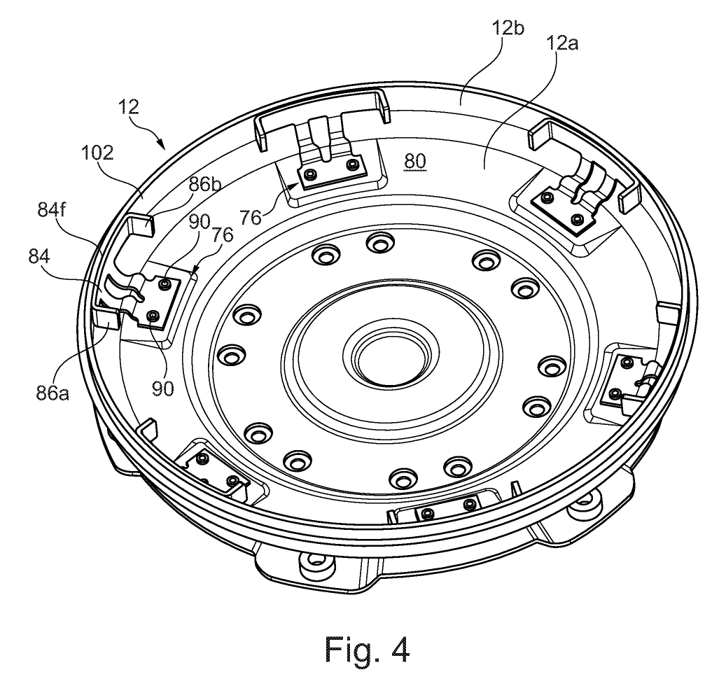

FIG. 2 shows a stand-alone perspective view of one of baffle assemblies 76. Base 78 is rectangular in shape and has a circumferential length greater than a radial length, such that a radially inner circumferentially extending edge 78a is longer than radially extending edges 78b, 78c. Base 78 is provided with two holes 88 passing axially therethrough for receiving rivets 90 (FIGS. 3, 4), with holes 88 extending from a first planar face 78e to a second planar face 78f. Arms 82 are circumferentially spaced from each other by a radially extending slot 90. Arms 82 each extend radially from a radially outer edge 78d of base 78 into a respective strengthening corrugation 92 for adding stiffness to each arm 82. Radially outside of corrugation 92, arms 82 each extend radially and axially at a curved segment 94 forming a radially outer end 82a of the respective arm 82. Ends 82a merge with a first circumferentially extending edge 84a of support 84.

Support 84 has a rectangular arc shaped—it has a rectangular shape when viewed radially and an arc shaped when viewed axially—and extends longitudinally in an arc-shaped path between two axially extending edges 84b, 84c, which are shorter in length than circumferentially extending edges 84a, 84d. Support 84 also includes an inner circumferential surface 84e and an outer circumferential surface 84f, which are delimited by edges 84a to 84d.

A first baffle 86a extends radially inward from axially extending edge 84b and a second baffle 86b extends radially inward from axially extending edge 84cd. Baffles 86a, 86b are each rectangular in shape and each include a radially outer axially extending edge 96a that is coincident with the respective edge 84b, 84c, a radially inner axially extending free edge 96b forming a radially innermost surface of the respective baffles 86a, 86b and two radially extending edges 96c, 96d extending radially from edge 96a to edge 96b. Baffles 86a, 86b both also each includes an outer planar face 96e facing circumferentially away from baffle assembly 76 and an inner planar face 96f facing circumferentially toward baffle assembly 76, with faces 96e, 96f being delimited by the respective edges 96a to 96d. As shown, faces 96e, 96f are substantially wider than edges 96a to 96d.

FIG. 3 shows an enlarged cross-sectional side view of the front cover 12 and one of the baffle assemblies 76. Baffle assembly 76 is fixed to radially extending section 12a of front cover 12 by two rivets 90 passing through holes 88 (FIG. 2) in base 78 and holes in radially extending section 12a. Baffle assembly 76 is fixed in place such that a first planar face 78e of base 78 rests flush against inner radially extending surface 80 of radially extending section 12a. Arms 82 protrude away from radially extending surface 80 at corrugations, then merge back toward front cover 12 at curved sections 94. Curved sections 94 nest in an inner curved surface 100 of a bend 12c of front cover 12, which joins radially extending section 12a and axially extending section 12b. Outer circumferential surface 84f of support 84 rests flush against an inner circumferential surface 102 of axially extending section 12b, with baffles 86a, 86b extending radially inward away from axially extending section 12b.

FIG. 4 shows a perspective view of the front cover 12 including a plurality of baffle assemblies 76 fixed thereto by rivets 90. In this embodiment, six circumferentially spaced baffle assemblies 76 are fixed to radially extending surface 80 of radially extending section 12a of front cover. Outer circumferential surfaces 84f of supports 84 contact inner circumferential surface 102 of axially extending section 12b of front cover and baffles 86a, 86b extending radially inward to impact fluid flow within torque converter 10.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A torque converter comprising:
a front cover, the front cover including a front radially extending section and a front axially extending section extending axially from an outer radial end of the front radially extending section; and
a plurality of baffle assemblies each including a base connected to the front radially extending section and a support connected to the base, each of the baffle assemblies including a first baffle and a second baffle extending radially inward from the respective support.

2. The torque converter as recited in claim 1 further comprising a plurality of rivets extending through the front radially extending section to fix the baffle assemblies to the front radially extending section, at least one of the rivets extending through each of the bases.

3. The torque converter as recited in claim 1 wherein each of the supports includes a first axially extending edge, a second axially extending edge and an outer circumferential surface extending longitudinally between the first and second axially extending edges, each of the first baffles extending from the respective first axially extending edge, each of the second baffles extending from the respective second axially extending edge.

4. The torque converter as recited in claim 3 wherein the outer circumferential surface of each of the supports contacts an inner circumferential surface of the front axially extending section.

5. The torque converter as recited in claim 1 wherein each of the baffle assemblies includes at least one arm extending radially and axially from the respective base to the respective support.

6. The torque converter as recited in claim 5 wherein each of the arms includes a corrugation.

7. The torque converter as recited in claim 5 wherein each of the arms includes a curved section nesting in an inner curved surface of a bend of the front cover, the bend joining the front radially extending section and the front axially extending section.

8. The torque converter as recited in claim 1 wherein each of the first and second baffles includes an outer planar face facing circumferentially away from the respective baffle assembly and an inner planar face facing circumferentially toward the respective baffle assembly.

9. A method of forming a torque converter comprising:
providing a plurality of baffle assemblies each including a base, a support connected to the base and a first baffle and a second baffle extending from the support; and
fixing the bases of the baffle assemblies to a radially extending section of the front cover such that the first and second baffles extend radially inward from the respective support.

10. The method as recited in claim 9 wherein the fixing includes riveting the bases of the baffle assemblies to the radially extending section of the front cover such that a plurality of rivets extend through the radially extending section of the front cover and at least one of the rivets extends through each of the bases.

11. The method as recited in claim 9 wherein each of the supports includes a first axially extending edge, a second axially extending edge and an outer circumferential surface extending longitudinally between the first and second axially extending edges, each of the first baffles extending from the respective first axially extending edge, each of the second baffles extending from the respective second axially extending edge.

12. The method as recited in claim 11 the fixing includes contacting an inner circumferential surface of an axially extending section of the front cover with the outer circumferential surface of each of the supports.

13. The method as recited in claim 9 wherein each of the baffle assemblies includes at least one arm extending radially and axially from the respective base to the respective support.

14. The method as recited in claim 13 wherein each of the arms includes a corrugation.

15. The method as recited in claim 13 wherein each of the arms includes a curved section nesting in an inner curved surface of a bend of the front cover, the bend joining the radially extending section and an axially extending section of the front cover.

16. The method as recited in claim 9 wherein each of the first and second baffles includes an outer planar face facing circumferentially away from the respective baffle assembly and an inner planar face facing circumferentially toward the respective baffle assembly.
